(19) United States
(12) Patent Application Publication
(10) Pub. No.: US 2007/0099706 A1
(43) Pub. Date: May 3, 2007

(54) Localization and customization of game related content

(75) Inventors: Yonathan Nuta, Seattle, WA (US); Erich Pleny, Redmond, WA (US); Dwain Scott Jacobsen, Issaquah, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/266,412

(22) Filed: Nov. 3, 2005

(51) Int. Cl. A63F 13/00

(52) U.S. Cl. 463/44

(57) ABSTRACT

A retail game kiosk system is provided game applications via a game media (DVD) comprising several different game configurations. Each game configuration is compatible with an intended recipient of the kiosk system. A game configuration is selected via a selector switch in the kiosk. When a game configuration is selected, the DVD is searched for the selected game configuration. If found, the selected game configuration is installed. If not found, a default game configuration is installed. Game configurations include game applications, languages, advertisements, and logos tailored to the intended recipient of the retail game kiosk. A single DVD can provide all the game configurations needed for all intended recipients of the retail game kiosks. Thus multiple DVD configurations need not be made.

### TECHNICAL FIELD

The technical field generally relates to game systems and more specifically relates to game systems for use in retail environments.

### BACKGROUND

Retail game kiosks are typically tailored for an intended retailer. For example, a game kiosk can comprise a game, logos, and advertisements specific to the retailer. To configure a retail game kiosk for a specific retailer, configuration specific software is installed into the kiosk. Typically, the software needed for each kiosk is provided with the kiosk. Thus, a kiosk destined for one retailer would be shipped with software tailored for that retailer and a kiosk destined for another retailer would be shipped with different software. The logistics and maintenance of various kiosks and configuration specific software can be difficult, time consuming, and burdensome. This is further exacerbated if the kiosk is to be removed from a retail cite and provided to another retailer, if the software is to be updated, or if kiosks are shipped to various countries.

### SUMMARY

A retail game kiosk system includes memory containing a variety of game configurations. Each game configuration is compatible with an intended recipient of the kiosk system. A game configuration is selected via a selector switch in the kiosk. When a game configuration is selected, the memory is searched for the selected game configuration. If found, the selected game configuration is installed and available for execution. In an exemplary embodiment, the memory comprises game media in the form of a disc having various game configurations stored thereon. A single game media can provide all the game configurations needed for all intended recipients of the retail game kiosk systems.

### BRIEF DESCRIPTION OF THE DRAWINGS

The following description is better understood when read in conjunction with the appended drawings. For purposes of illustrating the retail game kiosk system, there is shown in the drawings exemplary constructions of the retail game kiosk system; however, the retail game kiosk system is not limited to the specific methods and instrumentalities disclosed. In the drawings:

FIG. 1 is a diagram of an exemplary retail game kiosk system;

FIG. 2 is an illustration of an exemplary implementation of a retail game kiosk system; and

FIG. 3 is a flow diagram of an exemplary process for providing a game configuration to a retail game kiosk.

### DETAILED DESCRIPTION OF ILLUSTRATIVE EMBODIMENTS

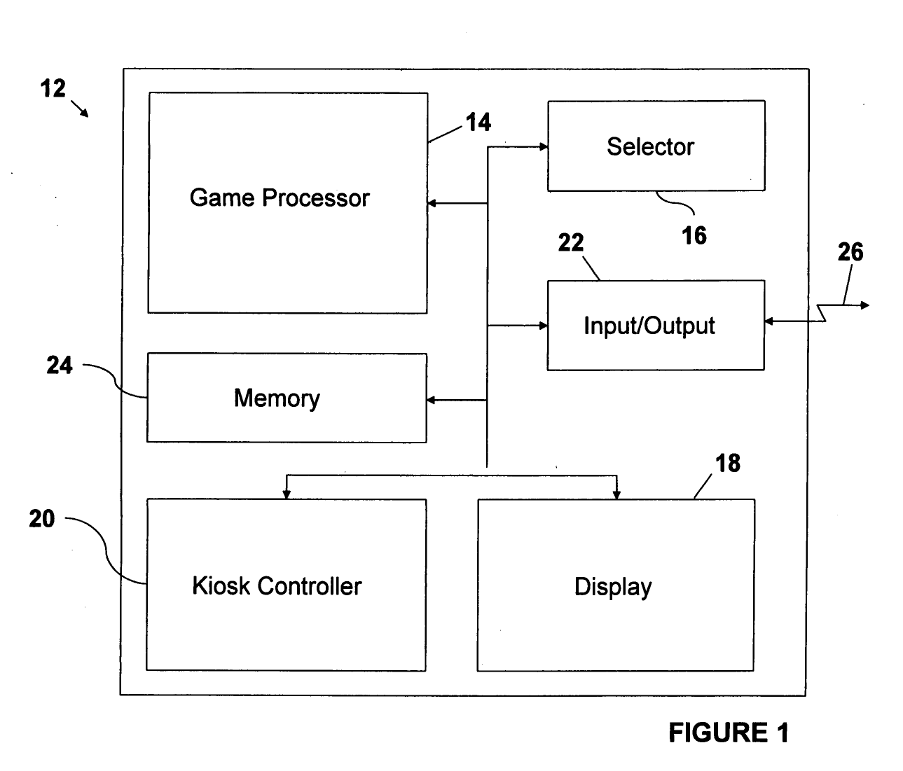

FIG. 1 is a diagram of an exemplary retail game kiosk system 12 comprising a game processor 14, a selector 16, a display portion 18, a kiosk controller 20, an input/output portion 22, and a memory portion 24. The game processor 14 can comprise any appropriate processor capable of executing a game application. In an exemplary embodiment, the game processor 14 comprises an XBOX® game processor. The display portion 18 can comprise any appropriate display device, such as a monitor, for rendering video. For example, the display portion 18 can comprise a liquid crystal display (LCD), a plasma display, a cathode ray tube (CRT), a light emitting diode (LED) display, or a combination thereof. The selector 16 can comprise any appropriate selection means for selecting a game configuration from a plurality of game configurations. The selector 16 can comprise a general purpose processor, a dedicated processor, hardware, software, or a combination thereof. In an exemplary embodiment, the selector 16 comprises a selector switch, such as an eight-pin dip switch for example.

The memory portion 24 can comprise any appropriate memory such as flash memory, ROM (Read Only Memory), RAM (Random Access Memory), volatile memory, non-volatile memory, semiconductor memory, magnetic memory, removable memory, non-removable memory, or a combination thereof for example. In an exemplary, a selected game configuration is stored in the memory portion 24.

The kiosk controller 20 provides control for, and functions as, an interface between the game processor 14 and other portions of the retail game kiosk system 12. The kiosk controller 20 provides functions such as supplying power to the game processor 14, interfacing the game processor 14 to the display 18, and an interfacing the game processor 14 to the input/output portion 22. The kiosk controller can comprise a general purpose processor, a dedicated processor, hardware, software, or a combination thereof.

The input/output portion 22 of the retail game kiosk system 12 is capable of providing coupling to any appropriate device, or devices, such as a peripheral, a host, and/or network, for example. The input/output portion 22 can comprise a port for hard wired coupling, a port for wireless coupling, or a combination thereof. The input/output portion 22 can comprise a Universal Serial Bus (USB) compatible port. The input/output portion 22 can comprise a port to provide audio information, such as via a headset or speakers, for example. In an exemplary embodiment, the input/output portion 22 comprises at least one drive for receiving a removable memory media, such as a disc for example. The input/output portion 22 provides and receives information via interface 26. The interface 26 can comprise any appropriate interface, or plurality of interfaces, such as wireless interfaces (e.g., RF, optical, cellular, wireless broadband etc), wired interfaces (e.g., hard-wired, docking station, USB compatible interface), or a combination thereof. In an exemplary embodiment, the input/output portion comprises a USB compatible port for coupling to a removable memory device, such as a flash memory device for example, to allow downloading of game characteristics (e.g., color coded race car), that can be implemented on a consumer game device. In this exemplary embodiment, the input/output portion 22 further comprises a drive for receiving an optical disc containing a plurality of game configurations.

In an exemplary embodiment, a removable memory media, such as a DVD for example, contains a variety of game configurations. A game configuration includes a game application and appropriate software tailored to a specific end user, such as a retailer. For example, a game configuration can contain a specific game application, software to render text in a specific language, and software to render various custom tailored aspects of the game application. For example, a game configuration can comprise an XBOX® game application, software to provide text in English, software to provide retailer advertisements, and software to allow a user to select the color of an action figure, such as a race car for example, in the game application. Game devices such as the XBOX® game device are sold in some geographic regions with the ability to change the cover of the XBOX® game device. The covers are available in different colors. Thus, a specific game configuration can provide the user with the ability to chose the color of a figure in the game application (e.g., chose the color of a race car) to match the color of the user's home game device (e.g., the user's consumer game device). The retail game kiosk system 12 provides, via the input/output portion 22 and the interface 26, the ability to download the race car in the chosen color (skin) such that the user can take the downloaded skin and transfer the skin to her home game device. Thus the user can play a game application on her home game device with a figure having a color that matches the color of the cover of her home game device.

In an exemplary embodiment, the selector 16 is configured to select one of the game configurations of a disc containing a plurality of game configurations. A signal is sent from the selector 16 to the kiosk controller 20. The signal is indicative of the selection. The kiosk controller 20 receives the signal and interprets the signal. When a disc is inserted into the input/output portion 22 of the retail game kiosk system 12, via software on the disc, a query is initiated against the kiosk controller 20 for the value of the selection indicative of a selected game configuration. The directory of the disc is searched for the selected game configuration. Upon finding the selected game configuration on the disc, the game configuration is loaded into the memory portion 24. The game application portion of the game configuration is loaded into the game processor 14. The games application is then available for execution. Other portions of the game configuration also are available for display and execution.

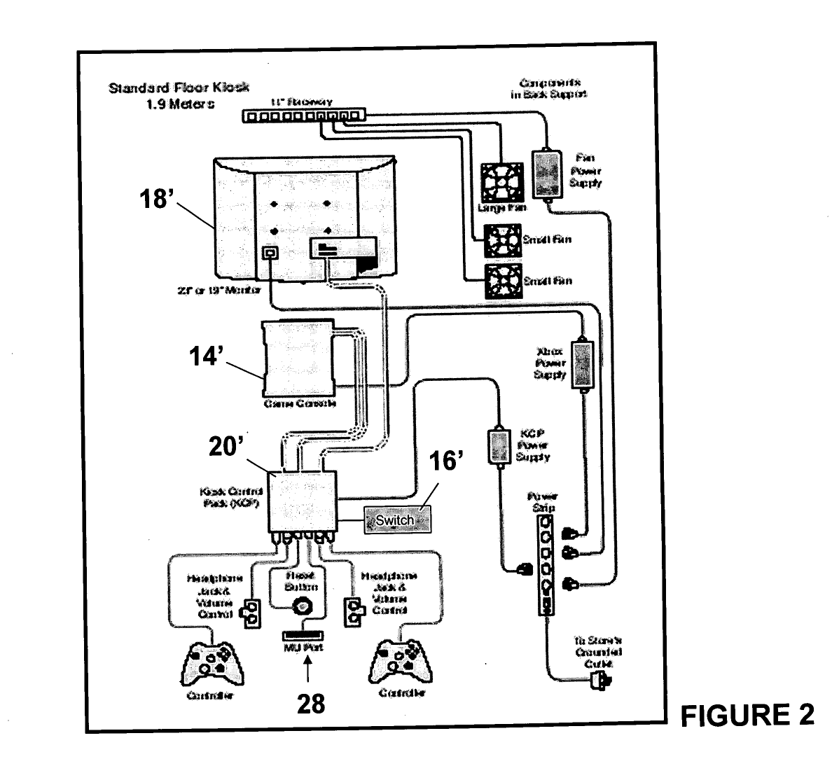

FIG. 2 is an illustration of an exemplary implementation of a retail game kiosk system. The retail game kiosk system shown in FIG. 2 comprises a monitor 18′ (analogous to the display portion 18 in FIG. 1), a game console 14′ (analogous to the game processor 14 in FIG. 1), a kiosk control pack 20 (analogous to the kiosk controller 20 in FIG. 1), and a switch 16′ (analogous to the selector 16 in FIG. 1). Game media, such as a DVD for example, can be inserted into a disc drive of the game console 14′ (disc drive of game console 14′ not shown in FIG. 2). It is envisioned that an external disk drive also can be coupled to the retail game kiosk system of FIG. 2 via port 28. For example, the port 28 can be a USB compatible port, and a USB compatible disk drive can be coupled to the retail game kiosk system via the port 28. In an exemplary embodiment, a disc containing a plurality of game configurations is inserted into the disc drive contained in the game console 14′ and the selected game configuration is obtained from the disc via the kiosk control pack 20′.

A signal is sent from the switch 16′ to the kiosk control pack 20′. The signal is indicative of the selection. The kiosk control pack 20′ receives the signal and interprets the signal. When a disc is inserted into the disc drive (e.g., disc drive of the game console 14′), kiosk software on the disc loads and queries the kiosk control pack 20′. The directory on the disc is searched for the selected game configuration. Upon finding the selected game configuration on the disc, the game configuration is loaded into the memory of the game console 14′. The game application is then available for execution. Other portions of the game configuration, such as logos and advertisements, also are available to the retail game kiosk system.

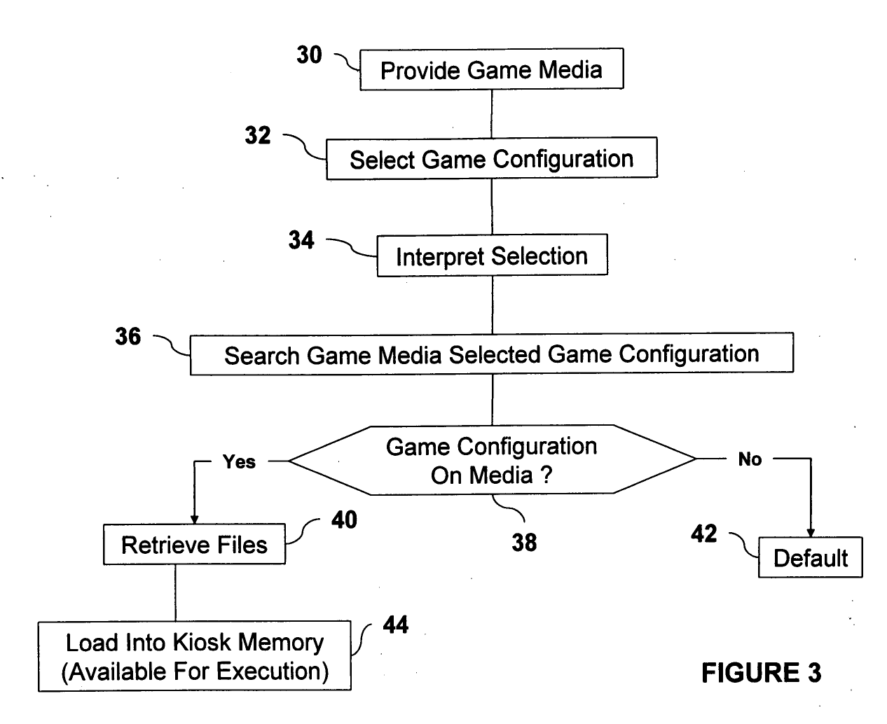

FIG. 3 is a flow diagram of an exemplary process for providing a game configuration to a retail game kiosk. The game media is provided at step 30. The game media can comprise an appropriate game media such as a floppy disc, a hard disc, an optical disc, a flash memory device, a transmission, a wired transmission, a wireless transmission, or a combination thereof for example. In an exemplary embodiment, a disc such as a DVD for example, is inserted into a disc drive. The contents of the disc are available to the retail game kiosk upon insertion of the disc. A game configuration is selected at step 32. In an exemplary embodiment, a switch is set, such as a dip switch, to a particular value or switch setting. The selection is interpreted at step 34. For example, a selector can be set to the value 110. The value 110 can be interpreted to indicate a specific game configuration. Another value can be indicative of another game configuration. For example, a value of 117 can be interpreted to be indicative of a selected game configuration comprising a race car application, in the English language to be installed at the Mall of America. Thus, the game configuration also could include advertisements for the various stores located at the Mall of America. In an exemplary embodiment, the following languages are supported by the plurality of game configurations: English, Spanish, French, Italian, German, Japanese, Korean, Portuguese, and Traditional Chinese.

The game media is searched for the selected game configuration at step 36. If the selected game configuration is found (step 38), the appropriate files associated the selected game configuration are retrieved from the game media at step 40. The game configuration retrieved from the game media is loaded into the retail game kiosk memory at step 44. Upon being loaded into the retail game kiosk memory, the game configuration is available for execution. If the selected game configuration is not found (step 38), a default condition is met at step 42. The default condition can comprise any appropriate default condition, such as providing an error message, retrieving default game configuration, or a combination thereof. In an exemplary embodiment, a default game configuration already exists in the retail game kiosk memory and is available for execution. For example, a default game configuration can comprise an English generic game configuration.

The various techniques described herein can be implemented in connection with hardware or software or, where appropriate, with a combination of both. Thus, the methods and apparatus for a retail game kiosk system, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing gaming on a retail game kiosk system. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language can be a compiled or interpreted language, and combined with hardware implementations.

The methods and apparatus for providing a game configuration to a retail game kiosk system also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing a method for controlling an application via a retail game kiosk system. When implemented on a general-purpose processor, the program code combines with the processor to provide a unique apparatus that operates to invoke the functionality of a retail game kiosk system. Additionally, any storage techniques used in connection with providing a game configuration to a retail game kiosk system can invariably be a combination of hardware and software.

A retail game kiosk system typically includes at least some form of computer readable media. Computer readable media can be any available media that can be accessed by a retail game kiosk system. By way of example, and not limitation, computer readable media can comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by a retail game kiosk system. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

While providing a game configuration to a retail game kiosk system and a retail game kiosk system have been described in connection with the exemplary embodiments of the various figures, it is to be understood that other similar embodiments can be used or modifications and additions can be made to the described embodiments for performing the same functions of gaming via a retail game kiosk system without deviating therefrom. Therefore, providing a game configuration to a retail game kiosk system and a retail game kiosk system as described herein should not be limited to any single embodiment, but rather should be construed in breadth and scope in accordance with the appended claims.

What is claimed:

1. A gaming system comprising:
a selector for:
selecting a game configuration for rendering in a game kiosk; and
providing a signal indicative of said selected game configuration;
a controller for:
receiving said signal indicative of said selected game configuration; and
responsive to receiving said signal, requesting from memory said selected
configuration; and
said memory for providing said selected configuration in response to said request,
said memory comprising a plurality of game configurations.

2. A system in accordance with claim 1, wherein said memory comprises a removable memory.

3. A system in accordance with claim 1, further comprising a retail game kiosk for housing said selector and said controller.

4. A system in accordance with claim 1, wherein each game configuration is tailored for at least one of an intended retailer and an intended country.

5. A system in accordance with claim 1, wherein a characteristic of each of said plurality of game configurations comprises at least one of a language of text to be rendered, a background color to be rendered, a game title, and a color of a game figure to be rendered.

6. A system in accordance with claim 1, further comprising an interface for providing at least one characteristic of a game configuration to a portable memory device.

7. A method for providing a game configuration to a game kiosk, said method comprising:
receiving, in a game kiosk, an indication of selected game configuration;
determining if said selected game configuration is one of a plurality of game configurations;
if said selected game configuration is one of said plurality of game configurations, loading said selected game configuration; and
executing said game configuration.

8. A method in accordance with claim 7, wherein said memory comprises a removable memory.

9. A method in accordance with claim 7, further comprising rendering a game in accordance with said selected game configuration.

10. A method in accordance with claim 7, wherein a characteristic of each of said plurality of game configurations comprises at least one of a language of text to be rendered, a background color to be rendered, a game title, and a color of a game figure to be rendered.

11. A method in accordance with claim 10, further comprising:
choosing selected ones of said characteristics; and
rendering a selected game configuration utilizing said selected ones of said characteristics.

12. A method in accordance with claim 7, further comprising providing at least one characteristic of a game configuration for use with a consumer game device.

13. A method in accordance with claim 7, wherein each game configuration is tailored for at least one of an intended retailer and an intended country.

14. A computer-readable medium having computer-executable instructions for performing the acts of:
receiving an indication of selected game configuration to be rendered on a retail game kiosk;
determining if said selected game configuration is one of a plurality of game configurations;
if said selected game configuration is one of said plurality of game configurations, loading said selected game configuration; and
executing said game configuration on said retail game kiosk.

15. A computer-readable medium in accordance with claim 14, wherein said memory comprises a removable memory.

16. A computer-readable medium in accordance with claim 14, said computer-readable medium having further computer-executable instructions for rendering a game in accordance with said selected game configuration.

17. A computer-readable medium in accordance with claim 14, wherein a characteristic of each of said plurality of game configurations comprises at least one of a language of text to be rendered, a background color to be rendered, a game title, and a color of a game figure to be rendered.

18. A computer-readable medium in accordance with claim 17, said computer-readable medium having further computer-executable instructions for:
choosing selected ones of said characteristics; and
rendering a selected game configuration utilizing said selected ones of said characteristics.

19. A computer-readable medium in accordance with claim 14, said computer-readable medium having further computer-executable instructions for providing at least one characteristic of a game configuration for use with a consumer game device.

20. A computer-readable medium in accordance with claim 14, wherein each game configuration is tailored for at least one of an intended retailer and an intended country.
